(19) United States
(12) Patent Application Publication
(10) Pub. No.: US 2006/0065160 A1
(43) Pub. Date: Mar. 30, 2006

(54) Method of producing cellulose acylate dope and solution casting method

(75) Inventor: Masaru Sugiura, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/233,186

(22) Filed: Sep. 23, 2005

(30) Foreign Application Priority Data
Sep. 24, 2004 (JP) 2004-276472

(51) Int. Cl. C09D 101/18; C08B 3/06

(52) U.S. Cl. 106/169.33; 536/69

(57) ABSTRACT

One of silicon dioxide particles and an acid whose pKa in water at 25° C. is from 1.9 to 4.5 is mixed in a polymer solution, such that a first liquid may be obtained, and another one is added to the first liquid. Thus a dope is obtained. Otherwise, a solvent, silicon dioxide particles and an acid whose acid dissociation constant (pKa) in water at 25° C. is from 1.9 to 4.5 are mixed, such that a second liquid in which a concentration of said acid is 0.5 wt. % may be obtained. The second liquid is added to a polymer solution, and thus a dope is obtained. A cellulose acylate film produced from each dope can be peeled from a support adequately, and aggregation of the particles are reduced. Therefore, a film whose optical properties are excellent is produced at high speed.

### BACKGROUND OF THE INVENTION

1. Field of the Invention

The present invention relates to a method of producing a cellulose acylate dope and a solution casting method with use of the cellulose acylate dope, and especially to a method of producing a cellulose acylate dope used for manufacturing an optical cellulose acylate film and a solution casting method for a film formation.

2. Description Related to the Prior Art

A cellulose acylate film is often used for a polarizing filter, in a liquid crystal display and soon, because of several features, such as optical characteristics, adequate moisture permeability, optical isotropy, mechanical properties and the like. The cellulose acylate film is usually manufactured by a solution casting method.

In the solution casting method, a liquid called a dope in which cellulose acylate, additives and the like are dissolved to or dispersed in a solvent is cast from a casting die onto a running support to form a casting film which is peeled as a film. Thereafter, the film is dried under predetermined conditions and then continuously wound up. Note that the addition of the predetermined particles is often made in a preparation process of the cellulose acylate dope, such that the film may contain the particles so as to prevent the adhesion of the wound-up film. As the particles, SiO₂ particles are used in view of a transparency of the film, a cost and the like.

Recently, in order to response to an expansion of demand for the liquid crystal display, it is extremely necessary to increase the productivity of the cellulose acylate film, and therefore a casting speed of the dope should be increased. In accordance with the increase of the casting speed, it is necessary to improve a peeling speed for peeling the casting film (or the dope on the support) from the support. However, if peelability is low, some defects occur on a film surface.

In order to increase the peelability of the casting film from the support, there is a method for decreasing a adhesive force of the cellulose acylate to the support (see, Japanese Patent Laid-Open Publication No. 10-316701). The adhesiveness between the casting film and the support occurs on the basis of hydrogen bonds between cellulose acylate and metal on a surface of the support and ionic bonds between the casting film and the support through calcium ions which are originally contained in cellulose acylate as a raw material of the casting film. Especially, the force of the ionic bonds is much larger than the hydrogen bonds. In the above publication, in order to decrease the force of the ionic bonds, an acid having a predetermined strength is added to the dope.

However, according to the method of the above publication, although the adhesive force to the support is reduced to increase the peelability, the SiO₂ particles have a tendency to aggregate more. When the aggregated SiO₂ particles are contained in the film, the optical features, such as transparency of the film and the like, become worse.

### SUMMARY OF THE INVENTION

An object of the present invention is to provide a method of producing a cellulose acylate dope containing an acid and SiO₂ particles, while the acid does not cause the aggregation of the SiO₂ particles.

Another object of the present invention is to provide a solution casting method with use of a cellulose acylate dope containing an acid and SiO₂ particles, while the acid does not cause the aggregation of the SiO₂ particles.

In order to achieve the object and the other object, in a method of producing a cellulose acylate dope of the present invention, while particles contains silicone dioxide and an acid dissociation constant (pKa) in water at 25° C. is from 1.9 to 4.5, one of the particles and the acid is firstly mixed into a cellulose acylate solution, such that a mixture may be obtained. Then another one of the particles and the acid is secondly mixed to the mixture such that the cellulose acylate dope may be obtained.

Preferably, the first mixing and the second mixing are inline mixing.

Preferably, the acid is polycarboxylic acid ester, particularly ciric acid ester. Further, a content of trimester is at most 10 wt. %, and a content of citric acid as impurity is at most 5 wt. % in the citric acid ester.

As another preferable embodiment of the method of producing a cellulose acylate dope of the present invention, a cellulose acylate solution is fed. While particles contains silicone dioxide and an acid dissociation constant (pKa) in water at 25° C. is from 1.9 to 4.5, a solvent, the particles and the acid are mixed in an inline mixing manner, such that a mixture in which a concentration is at most 0.5 wt. % may be obtained. Then the mixture is added inline to the cellulose acylate solution, such that the cellulose acylate dope may be obtained.

Preferably, the acid is polycarboxylic acid ester, particularly ciric acid ester. Further, a content of trimester in the citric acid ester is at most 10 wt. %, and a content of citric acid as impurity is at most 5 wt. %.

In a solution casting method of the present invention, while particles contains silicone dioxide and an acid dissociation constant (pKa) in water at 25° C. is from 1.9 to 4.5, at least one of the particles and the acid is firstly mixed into a cellulose acylate solution, such that a mixture may be obtained. Then another one of the particles and the acid is secondly mixed to the mixture such that a first dope may be obtained. The first dope is cast from a casting die onto a running support with a second dope which is different from the first dope, so as to form a casting film having plural layers in which a contacting layer to the support is formed from the first dope. The casting film is peeled as a film, and then the peeled film is dried.

In another preferable embodiment of a solution casting method of the present invention, a cellulose acylate solution is fed. While particles contains silicone dioxide and an acid dissociation constant (pKa) in water at 25° C. is from 1.9 to 4.5, a solvent, the particles and the acid are firstly mixed, such that a mixture in which a concentration is be 0.5 wt. % may be obtained. Then the mixture is secondly mixed inline to the cellulose acylate solution, such that a first dope may be obtained. The first dope is cast with a second dope from a casting die onto a running support, so as to form a casting film having plural layers in which a contacting layer to the support is formed from the first dope. The casting film is peeled as a film, and then the peeled film is dried.

According to the present invention, under the existence of the acid, the cellulose acylate dope containing the acid and the particles can be produced without occurrence of the aggregation of the particles. Thus, the peelability of the casting film from the support becomes higher such that the film production at high speed becomes possible, and the aggregation of the particles such as matting agents and the like is reduced such that the film production can be made with keeping the optical property of the produced film.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a schematic diagram of a first embodiment of a dope production apparatus to which the present invention is applied;

FIG. 2 is a partial schematic diagram of a second embodiment of the dope production apparatus;

FIG. 3 is a partial schematic diagram of a third embodiment of the dope production apparatus;

FIG. 4 is a schematic diagram solution casting apparatus to which the present invention is applied;

FIG. 5 is an explanatory view illustrating a situation for casting three sorts of dopes from a casting die to a support.

### PREFERRED EMBODIMENTS OF THE INVENTION

In followings, embodiments of the present invention will be explained. However, the present invention is not restricted in the embodiments.

As cellulose acylate of this embodiment, triacetyl cellulose (TAC) is especially preferable. TAC may be produced from cotton linter or cotton pulp, and preferable TAC is produced from cotton linter. It is preferable in cellulose acylate that the degree of substitution of acyl groups for hydrogen atoms on hydroxyl groups of cellulose preferably satisfies all of following formulae (I)-(III). In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.
2.5≦A+B≦3.0 (I)
0≦A≦3.0 (II)
0≦B≦2.9 (III)

A glucose unit constructing cellulose with β-1,4 bond has the free hydroxyl groups on 2^{nd}, 3^{rd} and 6^{th} positions. Cellulose acylate is polymer in which, by esterification, the hydrogen atoms on the part or all of the hydroxyl groups are substituted by the acyl groups having at least two carbon atoms. The degree of acylation is the degree of the esterification of the hydroxyl groups on the 2^{nd}, 3^{rd}, 6^{th} positions. In each hydroxyl group, if the esterification is made at 100%, the degree of acylation is 1. Therefore, if all of the three hydroxyl groups is esterified at 100%, the degree of acylation is 3.

Herein, if the acyl group is substituted for the hydrogen atom on the 2^{nd} position in a glucose unit, the degree of the acylation is described as DS2 (the degree of substitution by acylation on the 2^{nd} position), and if the acyl group is substituted for the hydrogen atom on the 3^{rd} position in the glucose unit, the degree of the acylation is described as DS3 (the degree of substitution by acylation on the 3^{rd} position). Further, if the acyl group is substituted for the hydrogen atom on the 6^{th} position in the glucose unit, the degree of the acylation is described as DS6 (the degree of substitution by acylation on the 6^{th} position). The total of the degree of acylation, DS2+DS3+DS6, is preferably 2.00 to 3.00, particylarly 2.22 to 2.90, and especially 2.40 to 2.88. Further, DS6/(DS2+DS3+DS6) is preferably at least 0.32, particularly at least 0.322, and especially 0.324 to 0.340.

In the present invention, the number and sort of the acyl groups in cellulose acylate may be only one or at least two. If there are at least two sorts of acyl groups, one of them is preferable the acetyl group. If the hydrogen atoms on the 2^{nd}, 3^{rd} and 6^{th} hydroxyl groups are substituted by the acetyl groups, the total degree of substitution is described as DSA, and if the hydrogen atoms on the 2^{nd}, 3^{rd} and 6^{th} hydroxyl groups are substituted by the acyl groups other than acetyl group, the total degree of substitution is described as DSB. In this case, the value of DSA+DSB is preferably 2.2 to 2.86, especially 2.40 to 2.80. Further, DSB is preferably at least 1.50, and especially at least 1.7. According to DSB, the percentage of the substitution on the 6^{th} position to that on the 2^{nd}, 3^{rd} and 6^{th} positions is at least 28%. However, the percentage is preferably at least 30%, particularly at least 31%, and especially at least 32%. Further, DSA+DSB of the 6^{th} position of the cellulose acylate is preferably at least 0.75, particularly at least 0.80, and especially at least 0.85. When these sorts of cellulose acylate are used, a solution (or dope) having preferable solubility can be produced, and especially, the solution having preferable solubility to the non-chlorine type organic solvent can be produced. Further, when the above cellulose acylate is used, the produced solution has low viscosity and good filterability.

In cellulose acylate, the acyl group having at least 2 carbon atoms may be aliphatic group or aryl group. Such cellulose acylate is, for example, alkylcarbonyl ester and alkenylcarbonyl ester of cellulose. Further, there are aromatic carbonyl ester, aromatic alkyl carbonyl ester, or the like, and these compounds may have substituents. As preferable examples of the compounds, there are propionyl group, butanoyl group, pentanoyl group, hexanoyl group, octanoyl group, decanoyl group, dodecanoyl group, tridecanoyl group, tetradecanyol group, hexadecanoyl group, octadecanoyl group, iso-butanoyl group, t-butanoyl group, cyclohexanecarbonyl group, oleoyl group, benzoyl group, naphthylcarbonyl group, cinamoyl group and the like. Among them, the particularly preferable groups are propionyl group, butanoyl group, dodecanoyl group, octadecanoyl group, t-butanoyl group, oleoyl group, benzoyl group, naphthylcarbonyl group, cinamoyl group and the like, and the especially preferable groups are propionyl group and butanoyl group.

Further, as solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like. Note that the dope is a polymer solution or dispersion in which a polymer and the like is dissolved to or dispersed in the solvent.

The solvents are preferably hydrocarbon halides having 1 to 7 carbon atoms, and especially dichloromethane. Then in view of the dissolubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recently in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable, and a mixture thereof can be used. These ethers, ketones and esters may have the ring structure. Further, the compounds having at least two of functional groups (namely, —O—, —CO— and —COO—) in ethers, ketones and esters can be used for the solvent. Further, the solvent may have other functional groups, such as alcoholic hydroxyl groups, in the chemical structure.

As particles in the present invention, the silicon dioxide (SiO₂) particles are used. SiO₂ used in this embodiment is sold in the market, and according to the state of the particle at supply for the dope production, the SiO₂ particles are primary particles in which the aggregation are hardly observed. By the prior method, the particles aggregate in the dispersing thereof in the solvent or the cellulose acylate solution, so as to form second particles. In this case, under the existence of an acid, the particles aggregate more to form larger particles. However, in the method of the present invention that is explained in the followings, the primary particle diameter can be almost kept.

The acid to be used in the present invention has an acid dissociation constant (pKa) from 1.9 to 4.5 in a water at 25° C. The preferable acid is esters of polycarboxylic acid, which are particularly esters of citric acid.

The esters of polycarboxylic acid usually contain polycarboxylic acids which are raw materials thereof. The content of the polycarboxylic acid is ascribed to that the esterification of the carboxylic acid is a reversible reaction. Although the carboxylic acid may be contained in view of the increase of the peelability from the support, this compound makes a reaction with calcium contained in cellulose acylate, and thus calcium salts are produced. The produced calcium salts precipitate and remain as impurities in the film, and otherwise adhere to the support to cause the roughness of the surface of the casting film at the forming thereof. Therefore, the content of the polycarboxylic acid as the impurities in the esters of the polycarboxylic acid is preferably lower, and concretely at most 5 wt. %. Consequently, if citric acid ester is used as polycarboxylic acid ester, The content of citric acid as impurities is preferably at most 5 wt. %.

Further, in polycarboxylic acid esters, while esters whose averaged degree of esterification is 100% have no carboxy groups, an intermolecular force is too small. Therefore, a volatility from the casting film or the film becomes higher than that of the esters in which esterification is partially made. If the volatility is higher, the production process is polluted, and accordingly, the running period thereof becomes shorter or the produced film sometimes has surface defects. Therefore, the content of esters whose averaged degree of esterification is almost 100% is preferably lower and concretely at most 10 wt. %. If the citric acid esters are used as polycarboxylic acid esters, it is preferable in the present invention that a content of mono- or diesters becomes larger, and a content of trimester is at most 10 wt. %.

Note that the detailed explanation of cellulose acylate is made from [0140] to [0195] in Japanese Patent Laid-Open Publication No. 2005-104148, and the description of this publication can be applied to the present invention. Note that the detailed explanation of the solvents and the additives (such as plasticizers, deterioration inhibitors, UV-absorptive agents, optical anisotropy controllers, dynes, matting agent, release agent, retardation controller and the like) is made from [0196] to [0516] in Japanese Patent Laid-Open Publication No. 2005-104148.

The film produced from the cellulose acylate dope of the present invention can be used for a polarizing filter, as a member of a liquid crystal display, and so on, because of a high dimensional stability. However, in view of inhibiting the deterioration under the circumstances in which the polarizing filter, the liquid crystal display or the like is used, the UV-absorptive agents are preferably added to the dope. The preferable UV-absorptive agent is excellent in absorption power of the UV-ray of at most 370 nm, and furthermore hardly absorbs the visible ray of at least 400 nm in view of the suitable displaying properties of the liquid crystal display. As concrete examples of the UV-absorbing agent to be used in the present invention, there are, for example, oxybenzophenone type compounds, benzotriazol type compounds, salitilic acid ester type compounds, benzophenone type compounds, cianoacrylate type compounds, nickel complex type compound and the like.

[Dope Production Method]

A production apparatus and a production method of the cellulose acylate dope of the present invention will be described below. Note that the following embodiments are examples of the present invention, and the present invention is not restricted in the embodiments.

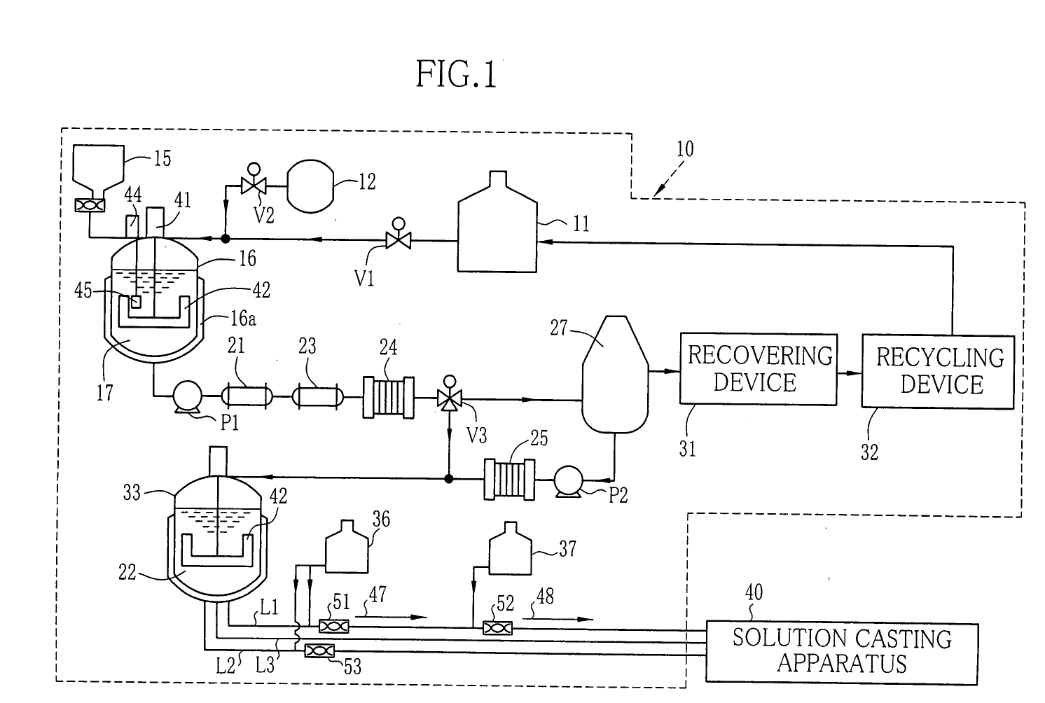

As shown in FIG. 1, a dope production apparatus 10 includes a first tank 11 for storing a solvent therein, a second tank 12 for storing predetermined additives, a hopper 15 for supplying TAC, and a third tank 16 for mixing the solvent, TAC and the predetermined additives. Further, the dope production apparatus 10 is provided with a heating device 21, a temperature controlling device 23, first and second filtration device 24, 25, and a flushing device 27. The heating device 21 heats a mixture 17 which is obtained by stirring the mixture in the third tank 16. Then the temperature controlling device 23 controls a temperature of the heated mixture 17 such that a polymer solution 22 may be obtained from the mixture 17. The flushing device 27 controls a concentration of the polymer solution 22.

Further, the dope production apparatus 10 includes a recovering device 31 for recovering the solvent, a recirculating device 32 for recycling the recovered solvent, and a fourth tank 33 for storing the polymer solution 22. The dope production apparatus 10 further has fifth and sixth tanks 36, 37 which are connected inline to a first feed line L1 among three feed lines between the fourth tank 33 and a solution casting apparatus 40. Furthermore, the fifth tank 36 is also connected inline to a second feed line L2. In the fifth tank 36, particles as a matting agent are accumulated, and the particles of this embodiment is silicon dioxide particles. Further, in the sixth tank 37, an acid as release agent is accumulated, and the acid of this embodiment is citric acid esters. The particles and the acid of the fifth and sixth tanks 36, 37 are sometimes accumulated in the original situation (namely, particles or original acid) without addition of the solvent, respectively, and sometimes accumulated in a situation of a solution or a dispersion in that they are dissolved to or dispersed in a predetermined solvent.

Note, the third tank 16 has a jacket 16a covering over an outer surface, a first stirrer 42 rotating in accordance with the drive of a motor 41, and a second stirrer 45 rotating in accordance with the drive of a motor 44. The jacket 16a forms a space on the outer surface of the third tank 16, and a heat transfer medium is fed into the space. The first stirrer 42 preferably has an anchor blade, and the second stirrer 45 is preferably an eccentric stirrer of a dissolver type. The dope production apparatus includes first and second feed pumps P1, P2, and valves V1-V3. However, positions and the numbers of the pumps and the valves are changed adequately.

Then the dope production method in which the dope production apparatus 10 is used will be explained below. First, the valve V1 is opened so as to feed the solvent from the first tank 11 to the third tank 16. TAC to be supplied to the hopper 15 is sent to the third tank 16 with the measurement of quantity thereof. The additives in the solution state or in the dispersion state in which they are dissolved or dispersed in the solvent are sent at necessary amount from the second tank 12 to the third tank 16 by opening the valve V2. The solvent of the additives are usually the same as that in the first tank 11. However, it may be changed in accordance with sort of additives.

If the additives are solid, a hopper and the like can be used instead of the second tank 12, so as to feed into the third tank 16. If several sorts of additives are added, a solution in which these sorts of additives are dissolved is prepared, then the solution is fed from the second tank 12 to the third tank 16, or the solutions of the additives are stored in respective plural tanks and fed to the third tank 16 through independent feed pipes. Further, if the additives are in the liquid state at the room temperature, the additives can be fed to the third tank 16 without using the solvent.

In this embodiment, the supply of the raw materials into the third tank 16 is performed in the order of the solvent, TAC and the additives, sequentially. However, the order is not restricted in this embodiment. For example, TAC, the solvent, the additives may be sequentially supplied. Note that the predetermined additives may not be mixed to TAC and the solvents at the timing of this embodiment. In consideration with sorts and properties of additives, the additives may be mixed in the following processes.

The inner temperature in the third tank 16 is controlled with use of the heat transferring medium flowing within the jacket 16a. The preferable inner temperature is in the range of −10° C. to 55° C. The solubility of cellulose acylate can be controlled depending on the types of the first and second stirrers 42, 45, sort of cellulose acylate, sort of the solvent and the like. Therefore, in this embodiment, the mixture 17 is obtained as swelling solution in which TAC is swollen in the solvent. However, the present invention is not restricted in this embodiment.

Then the mixture 17 is fed to the heating device 21 with use of the pump P1. The heating device 21 is preferably a pipe with a jacket. In heating the mixture 17, the dissolution of the swollen solid material in the mixture 17 proceeds. The temperature for dissolving in the heating device 21 is preferably in the range of 0° C. to 97° C. Therefore, the heating doesn't mean the heating over the room temperature, but the increase of the temperature of the mixture 17 fed from the third tank 16. For example, when the temperature of the fed mixture 17 is −7° C., the heating also means to increase the temperature to 0° C. and so on. Further, the heating device 21 is preferably provided with a pressurizer for pressurizing the mixture 17, so as to accelerate the dissolution efficiently.

Instead of the heat-dissolution with use of the heating device 21, the mixture 17 as swelling solution may be cooled more in the range of −100° C. to −10° C. so as to perform the dissolution, which is already known as the cool-dissolution method. In this embodiment, one of the heat-dissolution and cool-dissolution methods can be chosen in accordance with the properties of the materials, so as to control the solubility.

The heated mixture 17 is fed to the temperature controlling device 23, so as to control the temperature nearly to the room temperature. Thus the polymer solution 22 in which the polymer is dissolved to the solvent can be obtained. In this embodiment, the liquid fed out from the temperature controlling device 23 is called the polymer solution 22. However, the dissolution of TAC is usually completed through the heating device 21. The polymer solution 22 is filtrated with the first filtration device 24, so as to remove undissolved or insoluble materials. The filter used in the first filtration device 24 preferably has an averaged porous diameter of at most 100 μm. The flow rate of the filtration in the first filtration device 24 is preferably at least 50 little/hr. The polymer solution 22 after the filtration is fed through the valve V3 and accumulated in the fourth tank 33.

By the way, in the above method in which the mixture 17 is prepared and then the polymer solution 22 is obtained from the mixture 17, if it is designated that the polymer solution of higher concentration is produced, the time for production becomes longer. Consequently, the production cost sometimes becomes higher. Therefore, it is preferable that the polymer solution of the lower concentration than the predetermined value is prepared at first and then the enrichment of the polymer solution is made. As such method, as shown in FIG. 1, the polymer solution 22 has the lower concentration than the predetermined value, and after the filtration thereof through the first filtration device 24, the polymer solution 22 is sent to the flushing device 27 through the valve V3. In the flushing device 27, the solvent of the polymer solution is partially evaporated. The solvent vapor generated in the evaporation is condensed by a condenser (not shown) to a liquid state, and recovered by the recovering device 31. The recovered solvent is recycled by the recirculating device 32 and reused. According to this method, the decrease of cost can be designated, since the production efficiency becomes higher and the solvent is reused.

The polymer solution 22 after the enrichment as the above description is extracted from the flushing device 27 through the pump P2. Further, in order to remove bubbles generated in the polymer solution 22, it is preferable to perform the bubble removing treatment. As a method for removing the bubble, there are many methods which are already known, for example, an ultrasonic irradiation method and the like. Then the polymer solution is fed to the second filtration device 25, in which the undissolved and insoluble materials are removed. Note that the temperature of the polymer solution 22 in the second filtration device 25 is preferably in the range of 0° C. to 200° C. Further, the polymer solution 22 is fed to the fourth tank 33 and stored.

While the polymer solution 22 is fed from the fourth tank 33 to the solution casting apparatus 40 for casting the polymer solution 22, the particles from the fifth tank 36 and the acid from the sixth tank 37 are added inline through the respective feed lines to the polymer solution. Note in this description that the polymer solution is called a first liquid 47 after the particles are added, and the first liquid 47 is called a first dope 48 after the acid is added. Note in this figure that the indications of the first liquid 47 and the first dope 48 are applied to arrows showing the feeding directions.

There are inline mixers 51, 52 which are respectively disposed in downstream sides from the positions at which particles and the acid are added, and thus the mixing efficiency becomes higher. However, in the present invention, the order of the inline addition of the particles and the acid is may be reverse to that of this embodiment. Furthermore, in this embodiment, the dispersion or the solution of the particles and the acid is used for the addition, such that the adding speed may be the predetermined value. However, it is not necessary to make the addition of the dispersion liquid or the solution.

In the present invention, since the particles and the acid don't directly contact each other, the aggregation of the particles is reduced. In order to keep the effect for reduction of the aggregation, it is preferable that, after one of the particles and the acid is added and mixed such that the concentration thereof may be uniform, the other is added. Therefore, in this embodiment, when the particles are added, the mixture thereof is made by the inline mixer, and thereafter the acid is added. Further, in the present invention, if the acid whose acid dissociation constant (pKa) in the water at 25° C. is in the range of 1.9 to 4.5 is added, the adhesiveness of the film to the support in the film production apparatus (which will be explained below) is reduced. Thus the film is easily peeled from the support, and the aggregation of the particles is reduced. Consequently, the production speed of the film and the quality of the film become higher than in the prior arts.

Instead of the inline addition, at least one tank can be used for mixing the particles or the citric acid ethylester. If a number of the tank to be used is one, they may be added in the one tank. If a number of the tank is two or more, they may be added in the respective tanks. Concretely, after the particles and the polymer solution 22 are mixed in a predetermined tank, the addition of the acid is made in the same tank. Otherwise, after the particles and the polymer solution are mixed in a predetermined tank, a mixture liquid is fed to another tank, in which the addition of the acid is made. In consideration of these two methods, the latter method has higher production efficiencies obviously. However, in the point of the production efficiencies, namely the change for adding both materials and the continuousness of the production, the inline addition is more excellent than the addition in such one or more tanks. Especially, sort of particles or acid is sometimes changed in accordance with sort of dope to be produced. In the inline addition, in this case, the change of the sort can be performed without stopping the production line.

In this embodiment, both materials are added to the polymer solution 22 separately. However, the present invention is not restricted in it, and they may be added to the mixture 17 separately. Note that the addition to a liquid just before use in the solution casting apparatus as in this embodiment is especially effectively made, since the casting is performed before the occurrence of the continuous aggregation of the particles.

In the mixing of the particles and the acid to the polymer solution, it is preferable to use an inline mixer, such as the static mixer and the like as shown in this figure. Preferably, the static mixer has twisted blades as elements whose number is from 6 to 90, and especially from 6 to 60. As described above, in order to produce the film having three layer structure in the solution casting apparatus 40, the dope production apparatus 10 has the feed lines L1-L3 in which the dope are prepared by different preparation methods and then fed to the solution casting apparatus 40. Further, the first dope 48 containing the added particles and the added acid forms a first surface layer as a contacting layer to the support in the casting process in the solution casting apparatus 40.

Also into the second feed line L2, the particles in the fifth tank 36 are added inline, and the obtained liquid is stirred by the inline mixer 53, so as to stir and disperse enough. The liquid stirred by the inline mixer 53 is fed as a second dope to the solution casting apparatus 40, without adding the acid. Thus the second dope forms a second surface layer in an opposite side to the casting support. Further, still another liquid is fed as a third dope to the solution casting apparatus 40 through the third feed line L3 without adding the particles. Thus the third dope forms an intermittent layer between the first and second surface layers. Note that also when it is designated to form the film having the multilayer structure having at least four layers, the dope production methods of producing the first and second dopes used for respectively forming the first and second surface layers are the same as the above description, and the number of the intermittent layers is at least 2.

In the above methods, the produced dope has the TAC concentration in the range of 5 mass % to 40 mass %. Note that the dissolution method of the materials, the raw materials, the additives in the solution casting method for forming the TAC film is described in detail from [0517] to [0616] in Japanese Patent Laid-Open Publication No. 2005-104148, and the description of the publication can be applied to the present invention.

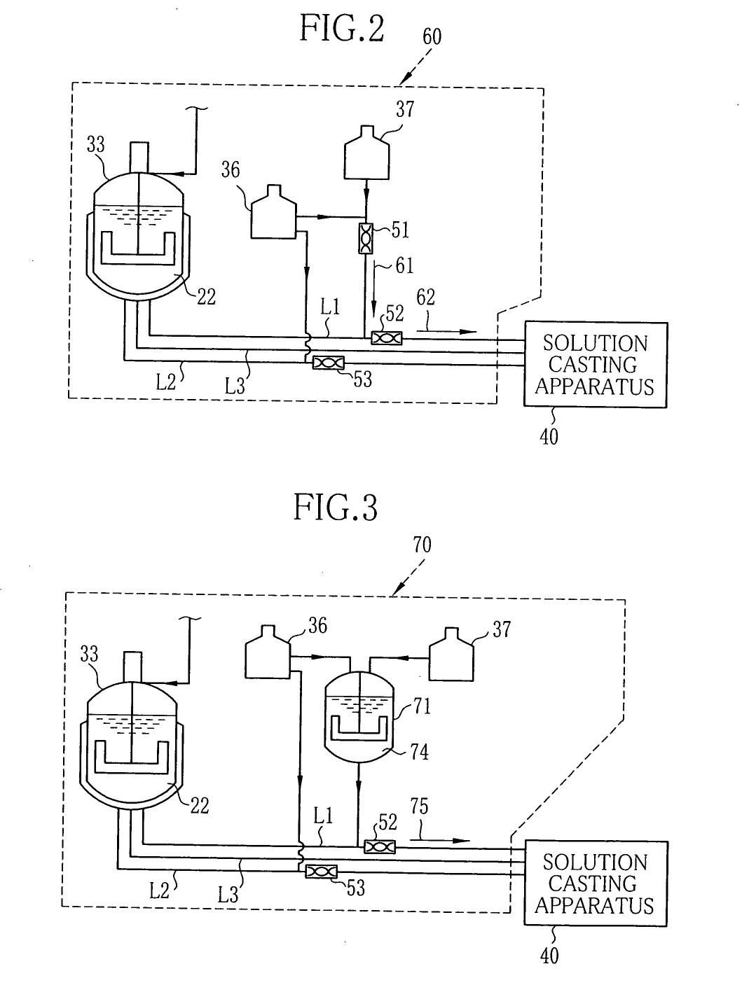

FIG. 2 shows a second embodiment of the present invention, in which the dope production apparatus is different from FIG. 1. In FIG. 2, the same numbers are applied to same devices and the same members, and the explanations thereof are omitted. Further, since the production line connecting to a fourth tank 33 is the same as that in FIG. 1, the explanation and illustration thereof are omitted. Also in this embodiment, a method for manufacturing the film having three layers is explained as an example. A dope production apparatus 60 includes the three feed lines from the fourth tank 33 as in the former embodiment. To the first feed line L1 are connected feed lines in which the particles of the fifth tank 36 and the acid of the sixth tank 37 respectively flow. The fifth tank 36 is connected inline to the second feed line L2.

The fifth tank 36 is connected inline to the feed line from the sixth tank 37 to the first feed line L1, and the inline mixer 51 is positioned just after the connection. Further, the inline mixer 51 is connected inline to the first feed line L1, and the second inline mixer 52 is positioned just after the connection. The inline mixer 53 is positioned just after the connection of the fifth tank 36 to the second feed line L2. The third feed line directly connects the fourth tank 33 and the solution casting apparatus 40. Note that the dispersion of the particles is accumulated in the fifth tank 36, and the solution of the acid is accumulated in the sixth tank 37.

The method of producing the dope with use of the dope production apparatus 60 is as follows. In this embodiment, the acid concentration of the acid solution in the sixth tank 37 is controlled to be more than 0 wt. % and at most 0.5 wt. %. Then the dispersion of the particles from the fifth tank 36 is added inline to the acid solution which is fed, and both of the particles and the acid are stirred by the inline mixer 51 enough, such that a second liquid 61 maybe obtained. Further, the second liquid 61 is added inline to the polymer solution 22 flowing in the first feed line L1, such that a second dope 62 may be obtained. Note in this figure that the numbers of the second liquid and the second dope are applied to arrows showing the feeding directions.

In this embodiment, the particles and the acid are contacted to each other before mixing with the polymer solution 22. However, the concentration of the acid solution to be added the dispersion of the particle is kept low as described above. Thus the aggregation of the particles is reduced in effect of the acid. In order to reduce the aggregation of the particles in effect of the acid, the concentration of the acid is preferably lower. Concretely, the concentration is preferably at most 0.5 wt. %, particularly at most 0.3 wt. %., and especially at most 0.1 wt. %. In consideration of the peelability of the cellulose acylate film from the support, it is preferable to decide the acid concentration, depending on the Ca content in cellulose acylate. Note that the Ca content in cellulose acylate can be measured in analysis methods which are well-known.

In this method, it is not necessary to supply the particles and the acids into the first feed line L1 with plural inline addition processes, and the apparatus can be more simple than the former embodiment. Further, in the method of this embodiment, a sample is obtained just after the mixing of the particles and the acid, and thus the situation of the dispersing of the particles can be recognized. Therefore, the second embodiment is effective in view of the check of the quality As described above, when the acid concentration of the acid solution is controlled to the predetermined value, the particles and the acid may be previously mixed. This idea is also applied to a method of a third embodiment which will be explained, and this method has the similar effects to the second embodiment.

FIG. 3 shows a dope production apparatus 70 in a third embodiment of the present invention. In FIG. 3, the same numbers are applied to same devices and the same members as FIG. 1, and the explanations thereof are omitted. Further, the processes until the fourth tank are the same as in the first embodiment. Therefore the illustration and explanation thereof are omitted as in the second embodiment.

The dope production apparatus 70 has three feed lines from the fourth tank 33 as in the first and second embodiments. In the same way as in the second embodiment, the feed line for feeding the particles from the fifth tank 36 and the acid from the sixth tank 37 is connected to the first feed line L1, and the fifth tank 36 is connected inline to the second feed line L2.

The fifth tank 36 and the sixth tank 37 are connected to a seventh tank 71 which is connected to the first feed line L1. An inline mixer 52 is positioned just after the connection of the seventh tank 71 and the first feed line L1, and an inline mixer 53 is positions just after the connection of the fifth tank 36 and the second feed line L2. The third feed line L3 directly connects the fourth tank 33 and the solution casting apparatus 40. In the fifth tank 36, the dispersion liquid of the particles is accumulated.

Also when it is designated that the dope is produced by the dope production apparatus 70, the acid concentration is controlled so as to be more than 0 wt. % and at most 0.5 wt. %. In this embodiment, the particles and the acid are not mixed inline but in the seventh tank 71. Therefore the acid concentration may be controlled in this range, and the situation of the particles to be added to the acid solution may be also the dispersion liquid or the solid state. Further, in the seventh tank 71 including the stirrer 72, the particles and the acid are stirred enough such that a second liquid 74 may be obtained. Then the second liquid 74 is added inline to the polymer solution in the feed line L1, such that a first dope 75 is obtained.

Note in this figure that the numerals of the second liquid and the first dope are applied to arrows showing the feeding directions.

In this embodiment, since the acid concentration of the acid solution to be supplied with the dispersion the particles is controlled to be low, the aggregation of the particle in effect of the acid is reduced.

As explained in the above first to third embodiments, the particles are not added to the acid before mixing them with the polymer solution, and otherwise, the particles are added to the acid before mixing them with the polymer solution while the acid concentration is controlled to the predetermined value. In these methods, the aggregation of the particles is reduced.

[Solution Casting Method]

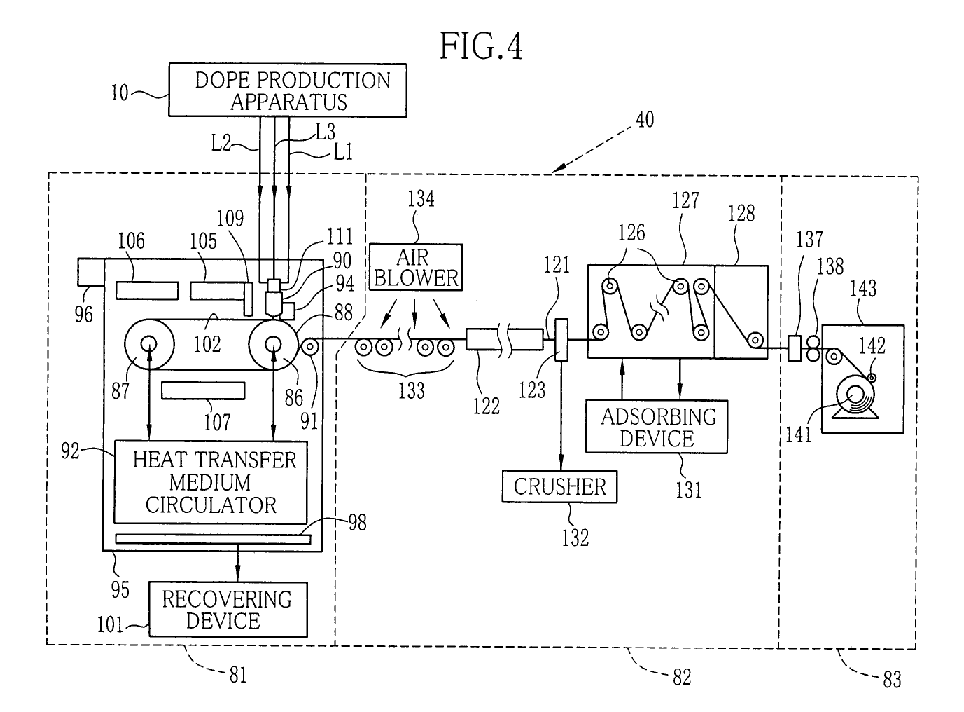

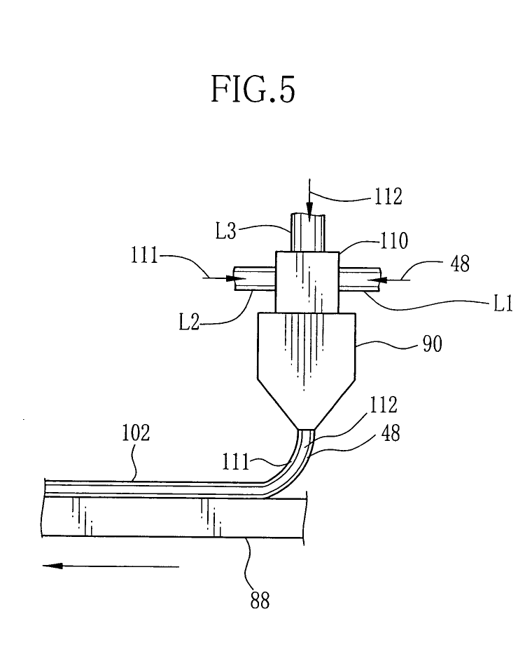

In followings, a solution casting method of manufacturing the film from the dope produced by the above dope production method will be described in reference with FIG. 4. Note that the present invention is not restricted in the solution casting apparatus of FIG. 4.

The solution casting apparatus 40 includes a casting section 81 for casting the dope, a drying section 82 for drying the film transferred from the casting section 81, and a winding section 83 for winding the dried film. However, these sections are not clearly partitioned in this apparatus.

At first, the explanation of the casting section 81 will be made. The casting section 81 includes a belt as a support 88 continuously running in accordance with the rotation of back-up rollers 86, 87, a casting die 90 for casting the dope onto the support 88, and a peel roller 91 for peeling the cast dope as the film. To the back-up rollers 86, 87 is attached a circulating device 92 for circulating a heat transferring medium, and surfaces of the back-up rollers 86, 87 are controlled by the circulating device 92. Further, there is a decompression chamber 94 for decompressing a space in a back side of a bead of the three dopes that is formed between the casting die 90 and the support 88.

The above instruments for the casting, such as the casting die 90 and the support 88, are contained in a casting chamber 95, in which there is a temperature controlling device 96 for controlling an inner temperature and a condenser 98 for condensing a vapor of the organic solvent. In an outside of the casting chamber 95, there is a recovering device 101 for recovering the condensed organic solvent.

Further, in the casting chamber 95, there are air blowers 105, 106, 107 for feeding air blows onto a casting film 102. In this embodiment, the position for attachment of each air blower 105, 106, 107 is in an upper and upstream side, an upper and downstream side, and a lower side of the support. However, the present invention is not restricted in it. Further, an air shielding device 109 is disposed close to the support 88 in the downstream side from the casting die 90.

Herein, each instrument for the casing included in the casting section 81 will be explained. As shown in FIGS. 4 & 5, there is a feed block 110 to which the dope is supplied. The preferable material of the casting die 90 is stainless steel of double phase type, having a complex composition of an austenitic phase and a ferrite phase, and the coefficient of thermal expansion is preferably at most 2×10⁻⁵(° C.⁻¹). Further, there is a material having anti-corrosion properties, which is almost the same as SUS316, in the examination of forcible corrosion in the electrolyte solution. Such material can be used. Preferably, the materials to be used for the casting die 90 has the anti-corrosion properties that the pitting doesn't occur on the gas-liquid interface even if the material is dipped in a mixture of dichloromethane, methanol and water for three months. The casting die 90 is preferably manufactured by performing the polishing after a month from the casting of the material. Thus the surface condition of the dope flowing in the casting die 90 is kept uniform. The finish precision of a contact face of the casting die to a feed block (explained later) is at most 1 μm in surface roughness and at most 1 μm/m in straightness. The clearance of a slit of the casting die 90 is automatically adjustable in the range of 0.5 mm to 3.5 mm. According to an edge of the contact portion of a lip end of the casting die 90, R (R is a chamfered radius) is at most 50 μm in all of a width. Further, the shearing speed in the casting die is controlled in the range of 1 to 5000 per second.

A width of the casting die 90 is not restricted especially. However, the width is preferably at least the same and at most 1.5 times as large as a film width. Further, it is preferable to attach a temperature controlling device (not shown) to the casting die 90, such that the temperature may be kept to the predetermined one during the film production. Furthermore, the casting die 90 is preferably a coat hanger type die. In order to adjust a film thickness, the casting die 90 is preferably provided with an automatic thickness adjusting device. For example, thickness adjusting bolts (heat bolts) are disposed at a predetermined interval in a widthwise direction of the casting die 90. Note that the film thickness is defined in consideration with a change of the thickness and the smoothness in the widthwise direction. Further, according to the heat bolts, it is preferable that the profile is set on the basis of a predetermined program, depending on feed rate of a pump (preferably, a high accuracy gear pump) 43. Further, the feed back control of the adjustment value of the heat bolts may be made by the adjusting program on the base of the profile of a thickness meter (not shown), such as infrared ray thickness meter and the like.

Preferably, a hardened layer is preferably formed on a top of the lip end. A method of forming the hardened layer is not restricted. But it is, for example, ceramics hard coating, hard chrome plating, neutralization processing, and the like. If ceramics is used as the hardened layer, it is preferable that the used ceramics have low wetting property. Concretely, there are tungsten carbide (WC), Al₂O₃, TiN, Cr₂O₃, and the like. Especially preferable ceramics is tungsten carbide. Tungsten carbide coating can be made by a spraying method.

Further, in order to prevent the partial dry-solidifying of a dope on a slit end of the casting die 90, it is preferable to provide a solvent supplying device (not shown) at the slit end, on which a gas-liquid interfaces are formed between both edges of the slit and both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). The solvent is preferably supplied to each edges of the bead from 0.01 mL/min to 10 mL/min. Thus the solidifications at both bead edges and the mixing of the solid into the casting film are prevented. Note that the pump for supplying the solvent has a pulse rate at most 5%.

The width and the length of the support 88 are not restricted especially. However, it is preferably 1.1 to 1.5 times as large as the casting width. The surface is preferably polished so as to have a surface roughness at most 0.05 μm. The support 88 is preferably made of stainless, and especially of SUS 316 so as to have enough resistance of corrosion and strength.

Note that it is possible to use a drum as the support. In this case, the drum is preferably a roller which can rotate at high accuracy such that the rotation unevenness caused by the eccentricity of rotary shaft may be at most 0.2 mm, and the surface roughness is preferably at most 0.01 μm. Further, the chrome plating is preferably performed to the drum such that the drum may have enough hardness and endurance. As described above, it is necessary in the support that the surface defect must be reduced to be minimal. Concretely there are no pin hole device (not shown), and thus the support 88 runs endlessly in accordance with the rotation of the back-up rollers 86, 87. Then the casting speed is preferably in the range of 10 m/min to 200 m/min. The drive of the back-up rollers 86, 87 is preferably controlled such that the tension generated in the support 88 may be 1.5×10⁴ kg/m and (the difference of) the relative speed between the support 88 and each back-up roller 86, 87 is at most 0.01 m/min. According to the control of the support 88, preferably, the change of the running speed is at most 0.5% from the predetermined value, and the meandering in the widthwise direction in one cycle running is at most 1.5 mm. In order to reduce the meandering, a detector (not shown) is preferably provided above each edge portion of the support 88, so as to make a feed-back control of the position of the belt on the basis of measured values. Furthermore, the position of the support 88 shifts up- and downwardly in accordance with the rotation of the back-up roller 86. Therefore, it is preferable that the position of the support 88 is preferably controlled just below the casting die 90, such that a shift range of the support 88 may be at most 200 μm.

Further, in this embodiment, the temperatures of the back-up rollers 86, 87 are controlled by a medium circulating device 92 for cycling a heat transfer medium. It is preferable that the surface temperature of the support 88 is adjusted in the range of −20° C. to 40° C. by heat transmission from the back-up rollers 86, 87. In this embodiment, passages (not shown) of the heat transfer mediums are formed in the back-up rollers 86, 87, and the heat transfer mediums whose temperatures are controlled by the medium circulating device pass through the passages. Thus the temperature of the back-up rollers 86, 87 are kept to the predetermined values. of at least 30 μm, at most one pin hole in the range of 10 μm to 30 μm, and at most two pin holes of less than 10 μm per 1 m².

Then the drying section 82 will be explained in the followings. The drying section 82 includes a tenter device 122, an edge slitting device 123 disposed in a downstream from the tenter device 122, a drying device 127 and a cooling device 128. The tenter device 122 dries a film 121 which has been obtained by peeling from the support 88, and stretches the film 121 in a predetermined direction. The edge slitting device 123 slits both side edge portions of the film 121. In the drying device 127, the film 121 whose side edge portions are slit off is dried with transfer of plural rollers 126, and then in the cooling device 128, the film 121 is cooled. The drying device 127 has an adsorbing device 131 for adsorbing and recovering the solvent vapor. Note that the edge slitting device 123 is connected to a crusher 132 for crushing dusts of the slit side edge portions of the film. Further, there is an air blower 136 in an interval section 133, before the enter of the film 121 into the tenter device 122.

The winding section 83 has a compulsory neutralization device (or a neutralization bar) 137 for controlling a charged electrostatic potential of the film 121 to a predetermined value, a knurling roller 138 for performing an embossing treatment to both side portions of the film 121, and a winding roller 141 for winding the film 121. The winding roller 141 includes a press roller 142 for controlling the film tension at the winding. Note that the winding roller 141 and the press roller 142 are included in a winding chamber 143.

Then the film manufacturing method with use of the solution casting apparatus 40 will be described below. The back-up rollers 86, 87 below the casting die 90 are rotated by the driving

In the present invention, the first—third dopes 48, 111, 112 produced as described above are cast so as to respectively form a first surface layer contacting to the support 88, a second surface layer positioned oppositely to the support 88, and an intermittent layer between the first and second surface layers. Preferably, the temperatures of the first—third dopes 48, 111, 112 are in the range of −10° C. to 57° C.

In the back side of the bead formed between the casting die 90 and the support 88, there is a decompression chamber 94 for controlling the pressure in the back side. Thus the formation of the bead is stabilized, and the wobbling of the bead is reduced. An inner temperature of the decompression chamber 94 is not restricted especially, and it is preferable to provide the decompression chamber 94 with a jacket for controlling the inner temperature. Further, aspirators may be provided with the decompression chamber 94 so as to be near both side edges of an outlet of the dope. Thus the aspiration in both side edges of the bead is made to stabilize the shape of the bead. In this case, the force velocity of the aspiration is preferably in the range of one to one hundred Litter/min.

The organic solvent evaporated from a casting film 97 on the support 88 is condensed by the condenser 98. The condensed organic solvent is recovered by the recovering device 101 and used as the solvent for preparing the dope.

Further, the drying airs from the air blowers 105, 106, 107 accelerate the evaporation of the solvent in the casting layer 102. Further, although the drying airs cause to change surface conditions of the casting film 102 just after the formation, the air shielding device 109 reduces the change of the surface conditions. The inner temperature of the casting chamber 95 is preferably controlled in the range of −10° C. to 57° C. by the temperature controlling device 96.

If necessary, a drying air at a predetermined temperature is applied by the air feeder 134 to accelerate the dry of the film 121 with the transportation to the tenter device 122. The temperature of the drying air from the air feeder 134 is in the range of 20° C. to 250° C. In the interval section 133, the rotation speed of the one roller is higher than the neighboring roller in the upstream side. Thus the tension can be applied to the film 121 in the transporting direction.

In the tenter device 122, both side edge portions of the film 121 are held by holding members, such as clips and the like, and the film 121 is dried with the transportation. The tenter device 122 of this embodiment stretches the film 121 in the widthwise direction. Thus, it is preferable in the interval section 133 and the tenter device 122 that the film 121 is stretched to become larger by 0.5% to 300% in at least one of the transporting direction (or a casting direction) and the widthwise direction. Preferably, the tenter device is partitioned, such that the drying condition (temperatures and the like) may be adjusted adequately in each partition.

The film 121 is dried until the content of the remaining solvent become the predetermined value, and then both side edge portions are slit off by the edge slitting device 123. The slit side edge portions are sent to the crusher 132 by a cutter blower (not shown), and crushed to tips by the crusher 132. The tips are reused for preparing the dope, which is effective in view of the decrease of the production cost. Note that the slitting process of both side edge portions may be omitted. However, it is preferable to perform the slitting between the casting process and the winding process in the winding section 83.

The film 121 whose side edge portions are slit off is sent to the drying device 127 and dried furthermore. In the drying device 127, the film 121 is transported with lapping partially around the rollers 126. The inner temperature of the drying device 127 is not restricted especially. However, it is preferable in the range of 100° C. to 150° C. The solvent vapor evaporated from the film 121 by the drying device 127 is adsorbed by the adsorbing device 131. The air from which the solvent components are removed is reused for the drying air in the drying device 127. Note that the drying device 127 preferably has plural partitions for variation of the drying temperature. Further, a pre-drying device (not shown) is provided between the edge slitting device 123 and the drying device 127, so as to perform the pre-drying of the film 121. Thus it is prevented that the temperature of the film 121 increases rapidly, and therefore the change of the shape of the film 121 is reduced.

In the cooling device 128, the film 121 is cooled to around the room temperature. A humidity control chamber (not shown) may be provided for conditioning the humidity between the drying device 127 and the cooling device 128. Preferably, in the humidity control chamber, an air whose temperature and humidity are controlled is applied to the film 121. Thus the curling of the film 121 and the winding defect in the winding process can be reduced.

Thereafter, the compulsory neutralization device (or a neutralization bar) 137 eliminates the charged electrostatic potential of the film 121 to the predetermined value (for example, in the range of −3 kV to +3 kV). The position of the neutralization process is not restricted in this embodiment. For example, the position may be a predetermined position in the drying section or in the downstream side from the knurling roller 138, and otherwise, the neutralization may be made at plural positions. After the neutralization, the embossing of both side portions of the film 81 is made by the embossing rollers to provide the knurling. The emboss height from the bottom to the top of the embossment is in the range of one micrometer to two hundred micrometers.

In the last process, the film 121 is wound by the winding roller 141. At this moment, a tension is applied at the predetermined value by the press roller 142. Preferably, the tension is gradually changed from the start to the end of the winding. In the present invention, the film 121 is at least 100 m in length, and at least 600 mm in width.

In the solution casting method of the present invention, there are casting methods for casting plural dopes, for example, a co-casting method and a sequential casting method. In the co-casting method, a feed block may be attached to the casting die as in this embodiment, or a multi-manifold type casting die (not shown) may be used. In the film of multi-layer structure, at least one of the thickness of the peeled layer from the support and that of the opposite layer thereto is preferably in the range of 0.5% to 30% of the total film thickness. Furthermore, when it is designated to perform the co-casting, a dope of higher viscosity is sandwiched by low-viscosity dopes. Concretely, it is preferable that the dopes for forming the surface layers have lower viscosity than the dope for forming a layer sandwiched by the surface layers. Further, when the co-casting is designated, it is preferable in the bead between die slit and the support that the composition of alcohol is higher in the two outer dopes than the inner dope.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Hardened, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

These functional layers preferably contain at least one sort of the surfactants in the range of 0.1 mg/m² to 1000 mg/m². Conditions and Methods for forming the functional layer are described in detail from [0890] to [1087] of Japanese Patent Laid-Open Publication No. 2005-104148, which can be applied to the present invention. Thus the produced film can have several functions and properties.

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No. 2005-104148 discloses the liquid crystal displays of TN type, STN type, VA type, OCB type, reflective type, and other types in detail. The description may be applied to the present invention. Further, in the description of this application, a cellulose acylate film is provided with an optically anisotropic layer, and another cellulose acylate film is provided with antireflective and antiglare functions. Further, the publication describes about the optically biaxial cellulose acylate film provided with adequate optical properties. This cellulose acylate film may be used with the protective film for the polarizing filter. These descriptions of the Publication No. 2005-104148 continues from [1088] to [1265], which can be applied to the present invention.

Various changes and modifications are possible in the present invention and may be understood to be within the present invention.

What is claimed is:

1. A method of producing a cellulose acylate dope, comprising steps of:
first mixing into a cellulose acylate solution one of particles containing silicon dioxide and an acid whose acid dissociation constant in water at 25° C. is from 1.9 to 4.5, such that a mixture liquid may be obtained; and
second mixing another one of said particles and said acid into said mixture liquid, such that said cellulose acylate dope may be obtained.

2. A method according to claim 1, wherein the first mixing and the second mixing are inline mixing.

3. A method according to claim 1, wherein said acid is polycarboxylic acid ester.

4. A method according to claim 3, wherein said polycarboxylic acid ester is citric acid ester.

5. A method according to claim 4, wherein a content of triester is at most 10 wt. % and a content of citric acid as impurity is at most 5 wt. % in said citric acid ester.

6. A method of producing a cellulose acylate dope, comprising steps of:
feeding a cellulose acylate solution;
mixing a solvent, particles containing silicon dioxide and an acid whose acid dissociation constant in water at 25° C. is from 1.9 to 4.5, such that a mixture liquid in which concentration of said acid is at most 0.5 wt. % may be obtained; and
mixing said mixture liquid to said cellulose acylate solution in an inline mixing manner, such that said cellulose acylate dope may be obtained.

7. A method according to claim 6, wherein said acid is polycarboxylic acid ester.

8. A method according to claim 7, wherein said polycarboxylic acid ester is citric acid ester.

9. A method according to claim 8, wherein a content of triester is at most 10 wt. % and a content of citric acid as impurity is at most 5 wt. % in said citric acid ester.

10. A solution casting method comprising steps of:
first mixing into a cellulose acylate solution one of particles containing silicon dioxide and an acid whose acid dissociation constant in water at 25° C. is from 1.9 to 4.5, such that a mixture liquid may be obtained;
second mixing another one of said particles and said acid into said mixture liquid, such that a first dope may be obtained;
casting from a casting die onto a running support said first dope with a second dope which is different from said first dope, so as to form a casting film having a first layer of said first dope and a second layer of said second dope, said first dope contacting to said support;
peeling said casting film as a film; and
drying said peeled film.

11. A solution casting method comprising steps of:
feeding a cellulose acylate solution;
first mixing a solvent, particles containing silicon dioxide and an acid whose acid dissociation constant in water at 25° C. is from 1.9 to 4.5, such that a mixture liquid in which a concentration of said acid is at most 0.5 wt. % may be obtained;
second mixing said mixture liquid to said cellulose acylate solution, such that said cellulose acylate dope maybe obtained;
casting from a casting die onto a running support said first dope with a second dope which is different from said first dope, so as to form a casting film having a first layer of said first dope and a second layer of said second dope, said first dope contacting to said support;
peeling said casting film as a film; and
drying said peeled film.
